(19) United States
(12) Patent Application Publication
(10) Pub. No.: US 2008/0115194 A1
(43) Pub. Date: May 15, 2008

(54) Authentication of modified data

(76) Inventor: John G. Apostolopoulos, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/591,029

(22) Filed: Oct. 31, 2006

(51) Int. Cl. H04L 9/32; G06K 9/00; G06F 17/30; G06F 15/16; G06F 7/04; G06F 7/58; G06K 19/00; G06F 15/173

(52) U.S. Cl. 726/4; 709/225

(57) ABSTRACT

Data processing in a network device is described. Data and authentication information used to authenticate the data may be received. The data may be adapted to produce modified data. The modified data may be transmitted with the authentication information. The authentication information may be used to authenticate the modified data.

### TECHNICAL FIELD

Embodiments in accordance with the present invention relate to data processing.

### BACKGROUND ART

The ability to adapt data to a multitude of diverse clients in heterogeneous networks with time-varying characteristics is a desirable property of data delivery systems. The data can be adapted at intermediate system nodes referred to herein as transcoders. A transcoder takes data as an input, and then processes it to produce adapted data as an output. Examples of transcoding operations include bit rate reduction, rate shaping, spatial downsampling, and frame rate reduction.

Providing proper security in order to protect data is another desirable property of data delivery systems. To provide security, data may be encrypted and subject to authentication. Data can be encrypted at its source and transported in encrypted form to its final destination. Authentication refers to verification of both the sender and the integrity of the data. Conventional authentication approaches employ message authentication codes (MACs) or digital signatures (DSs) to guarantee the identity of the sender and to determine whether the data has been accidentally or maliciously altered between the sender and the receiver.

There are at least two major penalties associated with data authentication. First, conventional authentication approaches are predicated on reliable data delivery. In other words, all of the data for which the MAC or DS was computed is needed at the receiver in order to authenticate the data. Thus, for example, authentication of a video that is streamed using User Datagram Protocol (UDP), where data packets may be lost without notice, may be problematic if a data packet is lost. Consequently, even those portions of the video that are received may not be usable if authentication is required. Therefore, the first penalty corresponds to the amount of data that is received but cannot be authenticated and as such may not be useful.

Second, MACs and DSs constitute additional overhead. This penalty can be reduced by amortizing the overhead cost over a group of data packets. However, there is a tradeoff between the number of data packets in the group and the probability of authentication—the larger the group, the lower the probability of authentication because if any of the packets in the group are lost, then the group cannot be authenticated.

With conventional approaches, if data to be authenticated is modified during delivery by transcoding, it cannot be authenticated and therefore is essentially useless and thereby equivalent to being lost. Thus, while transcoding facilitates scalability in data delivery systems, it poses a challenge to data authentication.

A solution to the conflict between transcoding and authentication is to provide multiple MACs per packet. For example, if there are N ways in which a packet can be scaled during transcoding, then N MACs are provided per packet, each MAC used for authenticating a respective version of the scaled data. However, this approach considerably increases the overhead already associated with authentication information. Also, this approach places a severe limitation on the granularity at which data can be transcoded and authenticated. To manage the amount of overhead, the number N of different versions cannot be large. Furthermore, it may not be possible to anticipate the granularity of transcoding that may be needed. Transcoding can be more efficiently managed at intermediate system or network nodes rather than at the source, because intermediate nodes can collect and update information about local and downstream network conditions and downstream receiver capabilities.

Accordingly, there is value to a method and/or system that permits both transcoding and authentication, in particular a method or system in which the granularity of transcoding is flexible without significant increases in overhead. Embodiments in accordance with the present invention provide these and other advantages.

### SUMMARY

Data processing in a network device is described. In one embodiment, data and authentication information used to authenticate the data are received. The data is adapted to produce modified data. The modified data is transmitted with the authentication information. The authentication information can be used to authenticate the modified data.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram showing an example of a network upon which embodiments of the present invention can be implemented.

FIG. 2 is a block diagram showing an example of a system upon which embodiments of the present invention can be implemented.

FIG. 3 is a data flow diagram illustrating a method for determining authentication information according to one embodiment of the present invention.

FIG. 4 is a data flow diagram illustrating a method for processing data according to one embodiment of the present invention.

FIG. 5 is a data flow diagram illustrating a method for authenticating data according to one embodiment of the present invention.

FIGS. 6 and 7 are flowcharts of methods for processing data according to embodiments of the present invention.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

Embodiments in accordance with the present invention are generally applicable to different types of data that are associated with information that is in turn based on the data, where it is desirable that the associated information remains valid even if the data on which it is based is altered. For example, embodiments in accordance with the present invention can be used with any type of data that can be altered (e.g., transcoded) but is to be authenticated. In one embodiment, the data includes media data (also referred to herein as multimedia data or media content). One example of media data is video data accompanied by audio data. However, media data can be video only, audio only, or both video and audio. In general, the present invention, in its various embodiments, is well-suited for use with speech-based data, audio-based data, image-based data, Web page-based data, graphic data and the like, and combinations thereof.

In an embodiment in which the data is video data, the video data may be compressed (encoded) using any of a variety of coding standards including, but not limited to, Moving Pictures Experts Group (MPEG) 1/2/4, MPEG-4 Advanced Video Coding (AVC), H.261/21314, JPEG (Joint Photographic Experts Group) including Motion JPEG, JPEG 2000 including Motion JPEG 2000, and 3-D subband coding.

The data may be encrypted using any of a variety of encryption standards. Encryption standards include, but are not limited to, the Data Encryption Standard (DES), Triple-DES, and the Advanced Encryption Standard (AES). These encryption primitives can be applied using a number of block-cipher modes including, but not limited to, electronic codebook (ECB), cipher block chaining (CBC), cipher-feedback (CFB), output feedback (OFB), and counter (CTR) modes.

The data may also be subject to authentication. Authentication techniques that may be used include, but are not limited to, authentication techniques such as message authentication codes (MACs), digital signatures (DSs), and hashes that are then aggregated with a single digital signal. Popular MACs include hash-based MACs such as Hashed Message Authentication Code (HMAC) using the Secure Hash Algorithm-1 (SHA-1) hash, or cipher-based MACs such as AES in CBC mode. Authentication techniques using symmetric key techniques or using public/private key techniques may be applied. Authentication can also use encryption primitives such as, but not limited to, AES and DES.

In one embodiment, data is encoded and encrypted in a manner that allows intermediate system or network nodes to adapt (e.g., transcode) the data by discarding parts of the encrypted and encoded data, without decrypting (and also without decoding) the data. This embodiment is referred to herein as “secure scalable streaming,” which incorporates “scalable encoding” and “progressive encryption.”

Secure scalable streaming is based on careful coordination of encoding, encrypting and packetizing operations. As used herein, scalable encoding is defined as a process that takes original data as input and creates scalably encoded data as output, where the scalably encoded data has the property that portions of it can be used to reconstruct the original data with various quality levels. Specifically, the scalably encoded data can be thought of as an embedded bitstream. A portion of the bitstream can be used to decode a baseline-quality reconstruction of the original data, without requiring any information from the remainder of the bitstream, and progressively larger portions of the bitstream can be used to decode improved reconstructions of the original data. For example, if an image is scalably encoded by resolution, then a small portion of the data can be used to decode a low-resolution image, a larger portion of the data can be used to decode a medium-resolution image, and all of the data can be used to decode a full-resolution image.

As used herein, progressive encryption is defined as a process that takes original data (plaintext) as input and creates progressively encrypted data (ciphertext) as output. Progressive encryption methods have the property that the first portion of the data is encrypted independently, and later portions are encrypted based on earlier portions. The plaintext is encrypted in a beginning-to-end or sequential manner, wherein a first portion of the bitstream is encrypted by itself, a second portion of the bitstream is encrypted using (e.g., in combination with) the first portion (either the encrypted or the unencrypted first portion may be used), and so on. Progressively encrypted data has the property that the first portion can be decrypted alone, without requiring information from the remainder of the original data; and progressively larger portions can be decrypted with this same property, in which decryption can use data from earlier but not later portions of the bitstream. When properly matched with scalable coding and packetization, progressive encryption provides the ability to transcode data by truncating or discarding data packets without decrypting the media data.

In one embodiment, the scalably encoded and progressively encrypted data is placed deliberately into data packets in a prioritized manner so that transcoding can be performed by truncating or discarding the packets, without decrypting the data. In one embodiment, the data is encoded into data packets that are progressively encrypted. Associated with each packet is a header that may or may not be encrypted. The header can be encrypted using an encryption technique that is different from that used to encrypt the data. If the header is encrypted, it can be decrypted without decrypting the data. The header of a packet includes information that identifies, for example, truncation points in the packet. A first truncation point may correspond to, for example, a first bitrate, resolution or quality level, a second truncation point may correspond to a second bitrate, resolution or quality level, and so on. To transcode or adapt the data to achieve the first level, for example, the header information is read and the first truncation point is identified. The packet can then be truncated at the first truncation point, so that data not needed to realize the first resolution or quality or bitrate level is discarded. The truncated packet is then forwarded to its next destination.

Although bitrate, resolution and quality are named in the examples above, embodiments in accordance with the present invention are not so limited. These and other examples herein are not intended to limit the breadth and scope of the invention, but rather to illustrate the variety of parameters that exist and that can be used as a basis for transcoding.

As used herein, truncation of a data packet refers generally to the removal of data from some part of the data packet. In one embodiment, the data is arranged in the packet so that data for a first resolution level, for example, is located in a first portion of the packet, data for a second resolution level is located in a second portion of the packet, and data for a third resolution is located in a third portion, where the second portion is located between the first and third portions. The header information identifies the points in the packet that demarcate the first, second and third portions. In this embodiment, if an image is to be reconstructed at, for example, only the first resolution level, then during transcoding the second and third portions can be truncated. That is, the data packet is in essence severed at the first truncation point, removing the second and third portions, leaving a smaller packet consisting of only the first portion (and the header).

In one embodiment, truncation points for a data packet are specified according to an analysis such as a rate-distortion (R-D) analysis, so that the stream of data packets can be compressed to a rate that is R-D optimal or nearly R-D optimal. In another embodiment, the header portions of the data packets contain information that describes the R-D curves generated by the R-D analysis, and the truncation points are derived from further analysis of the R-D curves.

Nearly optimal transcoding can be achieved at the data packet level by placing the optimal R-D cutoff points for a number of quality levels in the header portions of the data packets. Then, a transcoder can truncate each packet at the appropriate cutoff point; thus, the resulting packets will contain the appropriate number of bits for each region of the image for the desired quality level. The transcoder reads each packet header, and then truncates the packet at the appropriate point. For example, if three (3) regions in an image are encoded into separate packets, then 3 R-D optimal truncation points are identified for each region and their locations placed in the respective packet header. The transcoder can choose to operate at any of the 3 R-D points (or points in between), and then can truncate each packet at the appropriate cutoff point.

In another embodiment, the data is arranged in a data packet so that data for a first resolution level, for example, is placed in multiple portions of the packet, data for a second resolution level is located in other multiple portions of the packet, and data for a third resolution is located in yet other multiple portions of the packet. That is, data segments associated with the first resolution level, data segments associated with the second resolution level, and data segments associated with the third resolution level are interleaved in the packet. In this example, the header information identifies where the data segments that correspond to each resolution level are located in the packet. In this embodiment, if an image is to be reconstructed at, for example, only the first resolution level, then during transcoding the data segments associated with the first resolution level can be extracted from the packet and re-packetized. Alternatively, the data segments associated with the second and third resolution levels can be extracted from the packet and discarded. R-D coding can be achieved by generating an R-D curve for each segment at the same operating point that generates, for example, a desired bitrate. The R-D information is derived from the compressed but unencrypted data, and then included with the encrypted bitstream as “hints” that can be used to transcode the encrypted data without decrypting the data. The hints may or may not be encrypted. Using the R-D information provided by the hints, the data segments that have a lesser impact on the quality of the reconstructed image can be identified. During transcoding, the data segments corresponding to the frames of lesser importance can be dropped or extracted, as described above. The transcoding operation can be performed without decrypting the media data.

A premise of the discussion in the preceding paragraph is that the segment lengths do not matter—that is, there is not a constraint on bitrate so that, for example, some number of segments can be sent irrespective of their lengths—or the segments are of equal length. If there is a bitrate constraint, then segment lengths may be a factor to consider during transcoding—for example, it may be better to send two shorter segments instead of one longer one, or vice versa. Thus, in one embodiment, segments are ranked according to their relative “utility” (e.g., their importance per bit). In one embodiment, the utility of a segment is measured by the distortion per bit in the segment. That is, the amount of distortion associated with a segment (the amount of distortion that would result if the segment was dropped or discarded) is divided by the number of bits in the segment, and the ratio of distortion per bit provides the utility of the segment. Segments that have relatively higher utilities are forwarded, while segments that have relatively lower utilities can be dropped or discarded if necessary or desirable.

Instead of truncating packets, transcoding can be accomplished by discarding or dropping entire packets. Again, associated with each packet is a header that may or may not be encrypted. If the header is encrypted, it can be decrypted without decrypting the data. A first packet may contain data that, when decoded, is associated with, for example, a first bitrate, resolution or quality level, and a second packet may contain data that, when decoded and combined with the data in the first packet, is associated with a second bitrate, resolution or quality level. The header can include information that identifies which packets are associated with which of the levels. To transcode or adapt the data to achieve the first level, for example, the header information of each packet is read, the first packet is identified as being associated with the first level, and the second packet is identified as being associated with the second level. Accordingly, the first packet is forwarded to its next destination, and the second packet is dropped or discarded.

The header portion may also contain information identifying each data packet by number, for example. Accordingly, a transcoder can eliminate certain data packets from the stream; for example, if every other packet is to be eliminated (e.g., the odd-numbered packets), a transcoder can use the header information to identify the odd-numbered data packets and eliminate those from the stream of data packets.

To summarize to this point, transcoding can include: 1) packet truncation by truncating one or both ends of a packet; 2) packet truncation by discarding a portion or portions of the packet other than an end; and 3) discarding one or more packets in entirety.

The discussion above focused on encoders that are intended to provide scalability. However, embodiments in accordance with the present invention are also applicable to non-scalable encoders. This can be accomplished because encoders produce compressed bits, but some of the bits will be more important than other bits considering their impact on the quality of the reconstructed (decoded) image. By recognizing the relative importance of some bits versus other bits, the bits of greater importance can be identified so that during transcoding the bits of lesser importance can be dropped or discarded.

In one embodiment, R-D information for performing R-D optimized streaming is generated for the data. The R-D attributes are summarized in a “hint track” associated with the stream of data. While the data is encrypted for security, the hint track may not be encrypted. The R-D information in the hint track can be used to transcode the data, without decrypting the media data.

The discussion below describes the processing of data according to various embodiments in accordance with the present invention. In these various embodiments, the data may be scalable or non-scalable, scalably encoded or not, encrypted or not encrypted, and combinations thereof, as described above.

Also, the data may or may not be packetized into data packets. For example, instead of being discretely packetized, the data may exist as a bitstream or codestream. If packetized, the data can be transcoded by truncating a portion or portions of one or more data packets. If not packetized, the data can be transcoded by truncating a portion or portions of the bitstream or codestream.

FIG. 1 is a representation of a network 100 upon which embodiments of the present invention may be implemented. In the present embodiment, network 100 includes data (e.g., content) source 110 coupled to a number of interconnected server nodes 120, 121, 122 and 123. There may of course be a greater or lesser number of data sources and server nodes than those illustrated.

The interconnections between these nodes, including data source 110, may be a wired connection, a wireless connection, or a combination thereof. Each interconnection includes one or more channels, so that multiple streaming sessions between nodes can take place in parallel.

Generally speaking, data source 110 and server nodes 120-123 are types of devices that provide the capability to process and/or store data, and to send and receive such data. In one embodiment, server nodes 120-123 carry out transcoding operations and may therefore be referred to herein as “transcoding nodes.” “Transcoding” may also be referred to herein as “adapting” or “modifying.”

In one embodiment, data source 110 may be a storage device, and server nodes 120-123 may be computer systems as well as other types of devices that may not be typically considered computer systems but have similar capabilities. In another embodiment, data source 110 and server nodes 120-123 carry out processing operations, and as such may be computer systems as well as other types of devices.

In communication with network 100 are client devices such as client node 130, which may be a mobile device or a stationary device. In one embodiment, network 100 is for streaming data to client node 130. There may of course be multiple client nodes. The client node 130 may be coupled to the network 100 via a wired connection, a wireless connection, or a combination thereof.

In general, network 100 provides the capability to provide data from data source 110 to any of the intermediate server nodes 120-123, and/or from any of the intermediate server nodes 120-123 to another of the server nodes and/or to the client node 130. The route, or path, taken by the data as it travels from the data source 110 to the client node 130 may pass through any number of intervening nodes and interconnections between those nodes. Generally speaking, embodiments of the present invention pertain to the streaming of data from a sender to a receiver. Any of the nodes in network 100 may be considered a sender, and similarly any of the nodes in network 100 may be considered a receiver. The sender and receiver nodes may be adjacent nodes, or they may be separated by intervening nodes. Furthermore, in some embodiments, any of the nodes in network 100, including the data source 110 and the client node 130, can perform the processing of data described in conjunction with the figures below. Also, although client node 130 is illustrated as an end node in the network 100, the client node 130 may be a node within the network.

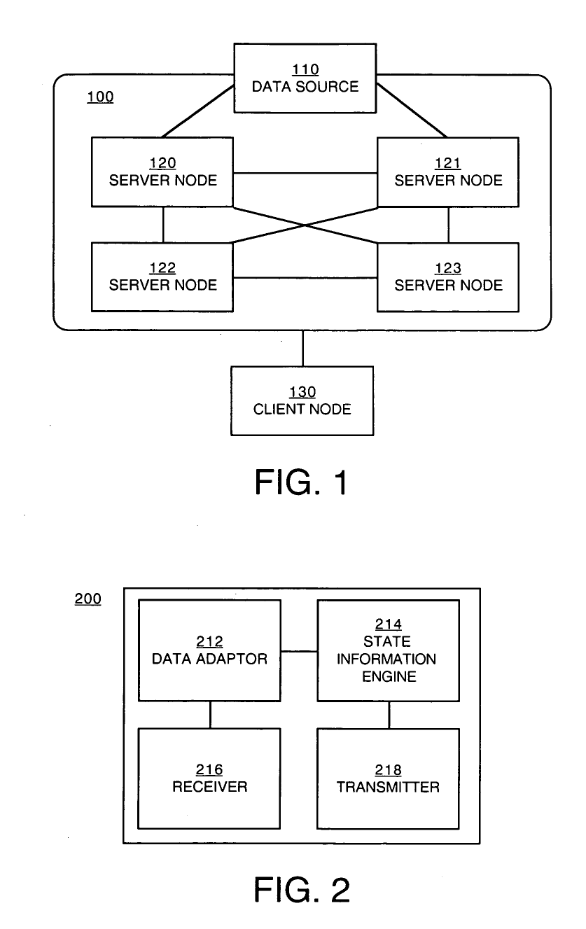

FIG. 2 is a block diagram showing an example of a system 200 upon which embodiments of the present invention can be implemented. In general, the elements of FIG. 2 are described according to the functions they perform. However, elements may perform functions in addition to those described herein. Also, functions described as being performed by multiple elements may instead be performed by a single element. Similarly, multiple functions described as being performed by a single (e.g., multifunctional) element may instead be divided in some way amongst a number of individual elements. Furthermore, the system of FIG. 2 and each of its elements may include elements other than those shown or described herein.

In the example of FIG. 2, the system 200 includes a data adaptor 212, a state information engine 214, and a transmitter 218. The system 200 may include a central processing unit and a memory (not shown). In one embodiment, device 100 also includes a receiver 216. Receiver 216 and transmitter 218 are capable of either wired or wireless communication.

In one embodiment, system 200 is implemented as a data source. In another embodiment, system 200 is implemented as a mid-network node.

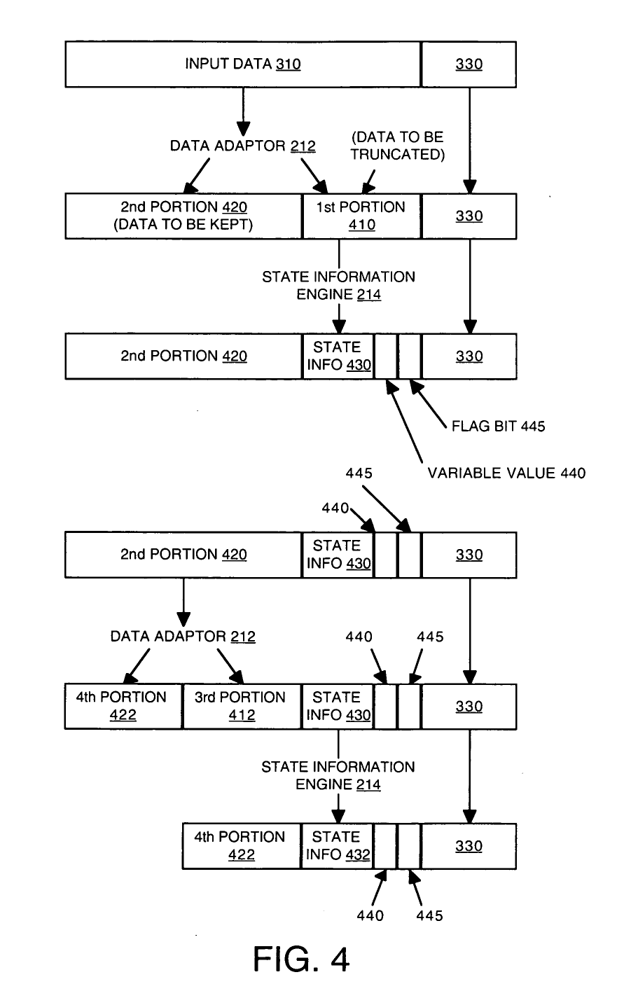

In one embodiment, data adaptor 212 adapts (e.g., transcodes or modifies) data as previously described herein. Data adaptor 212 may truncate the data, essentially removing or separating a first portion of the data from the original set of data while retaining the remaining, second portion of the original set of data. In one embodiment, state information engine 214 determines state information for the first portion of data according to the authentication technique being used. “State information” may also be referred to herein as “summary information.” Additional information is provided in conjunction with FIG. 4, below.

As mentioned previously herein, the data may be subject to authentication and, as such, authentication information may be associated with the data. As used herein, “authentication information” and “authentication value” each refer to a MAC, a digital signature, a hash aggregated with a digital signature, or the like. The data may be packetized or not. In one embodiment, if packetized, authentication information is associated with each data packet. For example, the authentication information may be appended to either end of a data packet. If not packetized, authentication information can be associated in some manner with the data. For example, the authentication information can be inserted at the beginning of a bitstream.

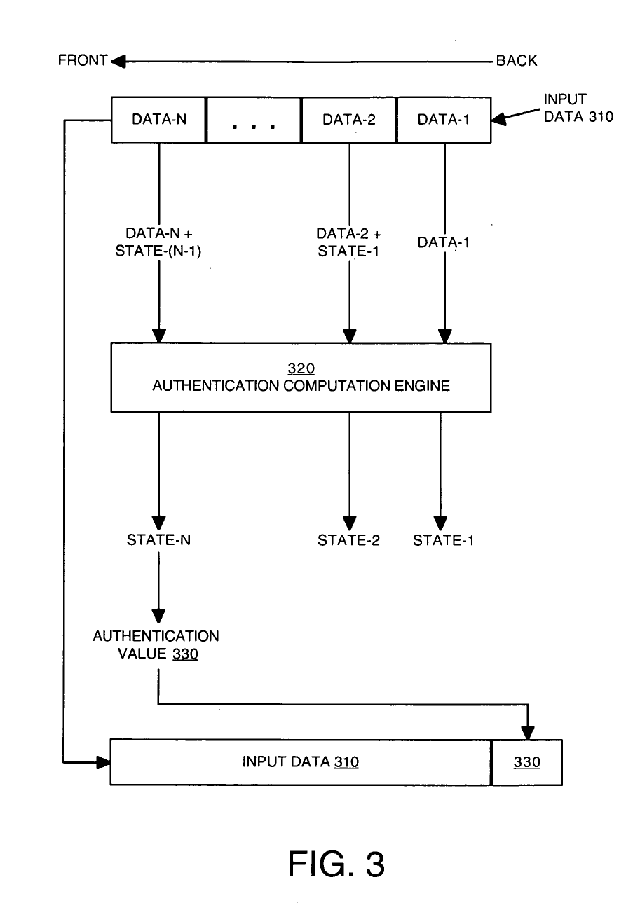

FIG. 3 is a data flow diagram illustrating a method for determining authentication information according to one embodiment of the present invention. In overview, authentication information 330 is determined by feeding the input data 310 into an authentication computation engine 320. In one embodiment, the authentication computation engine 320 resides at the source of the data (e.g., data source 110 of FIG. 1).

The authentication computation engine 320 of FIG. 3 can take a variable length input and produce a fixed length authentication value. For example, for 1500 bytes of data (e.g., a 1500-byte data packet), HMAC using SHA-1 produces a 20 byte MAC. To facilitate this variable-to-fixed length processing, the authentication computation engine 320 operates on one relatively small segment or window of the input data 310 at a time, while retaining state information about the previously examined segment(s) or window(s). For example, the authentication computation engine 320 selects 50 bytes of data (“data-1”) from the input data, determines state information (“state-1”) that summarizes data-1, uses the state-1 information plus another 50 bytes of input data (“data-2”) to determine state information (“state-2”) that summarizes data-1 and data-2, and so on, to determine state information (“state-N”) that summarizes the entirety of the input data 310. The state-N information can be used along with a secret key to determine authentication information 330 (e.g., a MAC value). The authentication information 330 can be associated with the input data 310 in some manner, as mentioned above.

Significantly, according to one embodiment of the present invention, to determine the authentication information 330, the input data 310 is processed from back to front (e.g., from the last bit or byte to the first) in order to facilitate data truncation during transcoding. For example, if the data 310 is packetized, then that data will reside in the payload portion of the data packet in a particular order; to determine the authentication information for the packet payload, the data is processed in reverse of that particular order.

As mentioned above, data may be arranged differently within a data packet or bitstream (e.g., data corresponding to a first resolution level may be in one portion of a data packet and data corresponding to a second resolution level may be in a second portion of the data packet, or instead data for the first and second resolution levels may be interleaved within a data packet), and transcoding is implemented accounting for the manner in which the data is arranged. In general, to determine the authentication information 330, the order in which data 310 is processed depends on the order in which the data is arranged in the packet or bitstream and hence the manner in which transcoding is to be performed. For example, if the tail of the data packet is to be truncated (in essence, chopped off), then the packet payload is processed from back to front, as mentioned above; if segments of data are to be extracted and re-packetized in a certain manner, then the packet payload is processed in a corresponding manner. The order in which the data 310 is processed can be agreed upon in advance or can be signaled in some manner in the data packets or bitstream.

FIG. 4 is a data flow diagram illustrating a method for processing data according to an embodiment of the present invention. In one embodiment, the method of FIG. 4 is performed using data adaptor 212 and state information engine 214, previously mentioned in conjunction with FIG. 2, above. In one such embodiment, the method of FIG. 4 is performed at the intermediate server, or transcoder, nodes 120-123 (FIG. 1).

With reference to FIG. 4, authentication information 330 is associated with data 310; that is, authentication information 330 was determined using data 310. In the example of FIG. 4, a portion of data 310 is to be truncated. Specifically, in the example of FIG. 4, a first portion 410 of the data is to be separated from data 310 and perhaps discarded, and a complementary second portion 420 is to be kept. The first portion 410 can be virtually any length, depending on the desired granularity of the transcoding. In one embodiment, the size of first portion 410 is an integer multiple of the size of the window used to determine authentication information 330 (see the discussion of FIG. 3).

Furthermore, the original authentication information 330 is kept. That is, the original authentication information 330 is not modified—it either passes through the transcoding node or is copied from the input of the transcoding node to the output of the transcoding node. As will be seen, the original authentication information 330 can be used to authenticate transcoded data; a new authentication value (e.g., a MAC value) does not need to be determined for the transcoded data. Consequently, the transcoding node does not need the secret key used by authentication computation engine 330 (FIG. 3), preserving end-to-end security.

In order for a receiver (e.g., client node 130 of FIG. 1) to authenticate the second portion 420 (the portion of data 310 that is to be kept) using the authentication information 330 (which was determined using the entirety of data 310), the first portion 410 (the portion of data 310 that is to be separated from data 310) is fed to state information engine 214, which determines state information 430 for the first portion 410.

In one embodiment, the sender, when creating the data portion 310 with associated authentication information 330, also appends in the data portion appropriate information that would aid in computing the appropriate state information 430 for the modified (e.g., truncated) data portion 420.

The state information 430 can be associated with second data portion 420 and authentication information 330 in some manner. For example, if the data is packetized as a data packet, then the state information 430 can be appended to the data packet. Alternatively, the state information 430 can be included in the bitstream.

In one embodiment, variable value 440 provides information that is sufficient for identifying the amount of data that was removed from data 310. In one such embodiment, variable value 440 is two bytes in length. The value of variable value 440 can indicate the length in bits of either first data portion 410 or second data portion 420, depending on the convention in use. A variable value 440 can be included in each data packet or in the bitstream.

In one embodiment, a flag bit 445 is set to indicate that the data associated with authentication information 330 is not the data used as the basis for determining the authentication information, but instead is a modified (e.g., transcoded) version of that data. In other words, a flag bit 445 can be set to indicate that data 310 has been modified.

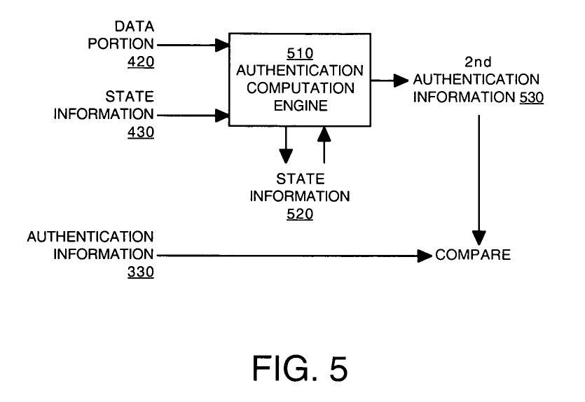

The second data portion 420, the state information 430 and the authentication information 330, along with variable value 440 and flag bit 445, can be sent to another of the intermediate server nodes 120-123 or to client node 130 (FIG. 1). The second data portion 420 can be authenticated as described in conjunction with FIG. 5 or further adapted as shown in FIG. 4.

With reference to FIG. 4, a third portion 412 of the data is to be separated from second data portion 420 and perhaps discarded, and a fourth portion 422 is to be kept. Furthermore, the original authentication information 330 is kept. In order for a receiver to authenticate the fourth portion 422 (the portion to be kept) using the authentication information 330 (which was determined using the entirety of data 310), the third portion 412 (the portion of data to be separated from second portion 420) is fed to state information engine 214 along with the state information 430 in a manner similar to that described above in conjunction with FIG. 3. Using third data portion 412 and state information 430, state information engine 214 determines state information 432, which summarizes both first portion 410 and third portion 412. The state information 432 can be associated with fourth data portion 422 and authentication information 330 in some manner, as described above. In one embodiment, variable value 440 is updated to indicate either the amount of data that has been removed (e.g., the total length in bits of first portion 410 and third portion 412) or the amount of data remaining (e.g., the length in bits of fourth portion 422), depending on the convention in use. In one embodiment, flag bit 445 remains set as described above.

The second data portion 422, the state information 432 and the authentication information 330, along with variable value 440 and flag bit 445, can be sent to another of the intermediate server nodes 120-123 or to client node 130 (FIG. 1). The second data portion 422 can be authenticated as described in conjunction with FIG. 5 or further adapted.

FIG. 5 is a data flow diagram demonstrating a method for authenticating data according to an embodiment of the present invention. In one embodiment, the method of FIG. 5 is implemented at a receiving device such as client node 130 of FIG. 1.

In the example of FIG. 5, the data that was kept (e.g., second data portion 420) and the state information for the data that was removed (e.g., state information 430) is fed to authentication computation engine 510 to determine state information 520, which in turn is used to determine second authentication information 530. Note that, in determining the state information 520 and authentication information 530, windows or segments of the second data portion 420 can be processed as described above in conjunction with FIG. 3. Authentication computation engine 510 employs the same authentication technique that was employed to determine authentication information 330.

Depending on the amount of data in second data portion 420, the authentication computation engine 510 can operate on one relatively small segment or window of the second data portion 420 at a time, while retaining state information about the previously examined segment(s) or window(s) in a manner similar to that described above in conjunction with FIG. 3. The authentication information 330 (the value that was determined at the data source) and the second authentication information 530 can then be compared; if the values match, then the second data portion 420 is authenticated. In this manner, the original authentication information 330 is used to authenticate the modified (e.g., adapted, truncated or transcoded) data. In other words, the data, although altered by transcoding, can still be authenticated.

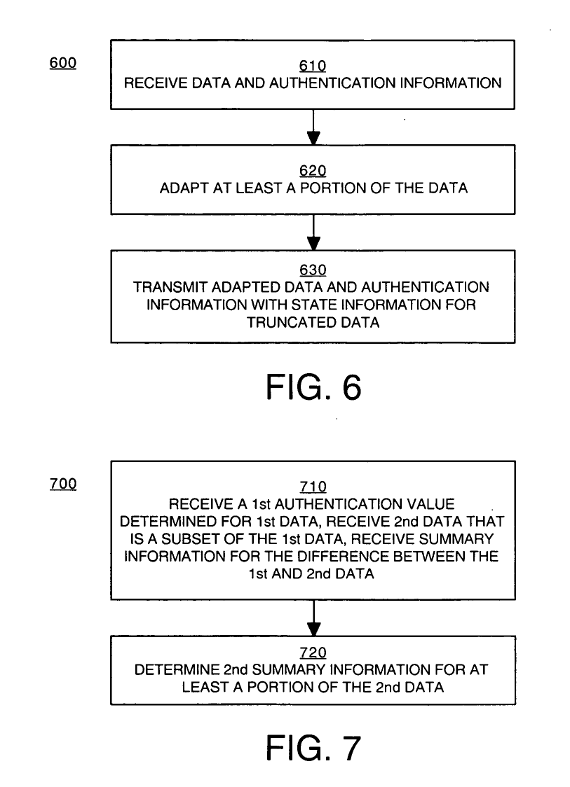

FIGS. 6 and 7 are flowcharts 600 and 700, respectively, of methods for processing data in accordance with various embodiments of the present invention. Although specific steps are disclosed in the flowcharts, such steps are exemplary. That is, embodiments of the present invention are well-suited to performing various other steps or variations of the steps recited in the flowcharts. The steps in the flowcharts may be performed in an order different than presented, and not all of the steps in the flowcharts may be performed. All of, or a portion of, the methods described by the flowcharts may be implemented using computer-readable and computer-executable instructions which reside, for example, in computer-usable media of a computer system.

In block 610 of FIG. 6, with reference also to FIGS. 3 and 4, data (e.g., data 310) and first authentication information (e.g., authentication information 330) for that data are received. Additional information, such as information useful for determining state information when the data is modified as described below, may also be received.

In block 620, at least a portion of the data is adapted to produce modified data (e.g., second data portion 420). In one embodiment, a first portion (e.g., first data portion 410) of the data to be separated from the data is identified. In one embodiment, summary information (e.g., state information 430) is determined for the first portion of data. In one such embodiment, the first portion of data is separated from the data to produce the modified data (e.g., second data portion 420).

In block 630, in one embodiment, the modified data (e.g., second data portion 420), the summary information (e.g., state information 430) and the first authentication information (e.g., authentication information 330) are transmitted. The summary information and the modified data are useful for determining second authentication information (e.g., authentication information 520 of FIG. 5) that can be compared to the first authentication information to authenticate the modified data. Consequently, the first authentication information remains useful for authenticating the modified data.

In one embodiment, information (e.g., variable value 440) sufficient for identifying the length of the portion of data that was separated from the data is also transmitted. In one embodiment, information (e.g., flag bit 445) indicating that the first authentication information is being transmitted with the modified data (e.g., second data portion 420) instead of with the original data (e.g., data 310) is also transmitted.

In block 710 of FIG. 7, with reference also to FIGS. 4 and 5, a first authentication value (e.g., authentication information 330) determined using a first plurality of data (e.g., data 310) is received. A second plurality of data (e.g., second data portion 420) that is a subset of the first plurality of data is also received. First summary information (e.g., state information 430) for a third plurality of data (e.g., first data portion 410) corresponding to the difference between the first plurality of data and the second plurality of data is also received.

In block 720, the first summary information, in combination with the second plurality of data, is used to determine second summary information for at least a portion of the second plurality of data. As used herein, “at least a portion” refers to some or all of the second plurality of data. In other words, in block 720, second summary information may be determined for all of the second plurality of data (e.g., second data portion 420), or second summary information may be determined for a portion (e.g., third data portion 412) of the second plurality of data. Note that, in determining the second summary information for any portion, including all, of the second plurality of data, windows or segments of the second plurality of data can be examined as described above in conjunction with FIG. 3.

In one embodiment, in which all of the second plurality of data is processed in block 720, a second authentication value (e.g., authentication information 520) is determined. The second authentication value can be compared to the first authentication value to authenticate the second plurality of data.

In one embodiment, in which not all of the second plurality of data is processed in block 720, the first authentication value, the second summary information and the remainder of the second plurality of data is transmitted to a second device (e.g., client node 130 of FIG. 1). The second device may use the second summary information and the remainder of the second plurality of data to determine a second authentication value that can be compared to the first authentication value to authenticate the remainder of the second plurality of data. Alternatively, the second device may process only a portion (not all) of the second plurality of data, to determine summary information for that portion, which in turn can be passed to another device along with the first authentication information and the remainder of the second plurality of data (minus the portion processed) for further processing.

In summary, embodiments in accordance with the present invention provide methods and systems that permit both transcoding and authentication. An original set of data is used to determine an authentication value. State information is determined for any data removed from the original set by transcoding, and that state information can subsequently be used along with the remaining data to determine an authentication value that can be compared to the authentication value for the original set of data. Because state information is determined for the data that has been removed by transcoding, the amount of data so removed is not limited to any particular amount. Accordingly, relative to conventional approaches, much finer granularity is permitted; that is, according to embodiments of the present invention, smaller amounts of data can be truncated without significantly increasing overhead. If data is transcoded (e.g., truncated), then the amount of authentication overhead is increased only by the size of the state information (which is a function of the authentication technique used), the length of a variable that describes the amount of data removed (or the amount of data remaining), and a flag bit that indicates that the original data has been modified.

Furthermore, the degree of transcoding is flexible—the degree of transcoding can be determined at the transcoding node instead of trying to anticipate the degree of transcoding at the data source. Also, end-to-end security is preserved because the transcoding node does not need the secret key that was used by the data source for authentication.

Moreover, according to embodiments of the present invention, authentication is resilient to packet losses because authentication information can be provided on per-packet basis without introducing a conflict between authentication and transcoding.

Embodiments of the present invention are thus described. While the present invention has been described in particular embodiments, it should be appreciated that the present invention should not be construed as limited by such embodiments, but rather construed according to the following claims.

What is claimed is:

1. In a device communicatively coupled to a network, a method of processing data, said method comprising:
receiving a plurality of data having first authentication information associated therewith, wherein said first authentication information was determined using said plurality of data and is useful for authenticating said plurality of data;
adapting at least a portion of said plurality of data to produce a plurality of modified data; and
transmitting said plurality of modified data and said first authentication information, wherein said first authentication information is useful for authenticating said plurality of modified data.

2. The method of claim 1 wherein said adapting and transmitting further comprise:
identifying a portion of said plurality of data to be separated from said plurality of data;
determining summary information for said portion of data to be separated, wherein said summary information and said plurality of modified data are useful for determining second authentication information that can be compared to said first authentication information to authenticate said plurality of modified data;
separating said portion of data from said plurality of data to produce said plurality of modified data; and
transmitting said summary information in addition to said plurality of modified data and said first authentication information.

3. The method of claim 2 further comprising transmitting information sufficient for identifying the length of said portion of data that was separated from said plurality of data.

4. The method of claim 2 further comprising receiving information useful for determining said state information.

5. The method of claim 1 further comprising transmitting information indicating that said first authentication information is being transmitted with said plurality of modified data instead of with said plurality of data.

6. The method of claim 1 wherein said first authentication information was determined by processing said plurality of data in a particular order, wherein information indicating said order is included with said plurality of data.

7. The method of claim 1 wherein said first authentication information was determined using a secret key, wherein said processing is performed without said secret key.

8. The method of claim 1 wherein said plurality of data is packetized, wherein said adapting comprises truncating a data packet.

9. In a first device communicatively coupled to a network, a system for processing a plurality of data that has first authentication information associated therewith, said system comprising:
a data adaptor operable for identifying a first portion of said plurality of data and a second portion of said plurality of data;
a state information engine coupled to said data adaptor and operable for determining state information for said first portion, wherein said state information and said second portion when used together are useful for determining second authentication information that can be compared to said first authentication information to authenticate said second portion; and
a transmitter coupled to said state information engine and operable for sending said first authentication information, said state information and said plurality of data minus said first portion to a second device communicatively coupled to said network.

10. The system of claim 9 wherein information useful for identifying a length of said first portion is also sent to said second device.

11. The system of claim 9 wherein information indicating said first authentication information is being transmitted without all of said plurality of data is also sent to said second device.

12. The system of claim 9 wherein said first authentication information was determined by processing said plurality of data in a particular order, wherein information indicating said order is included with said plurality of data.

13. The system of claim 9 wherein said plurality of data is packetized into a data packet comprising a packet payload that is truncated by said data adaptor, wherein said first portion corresponds to a portion of said packet payload that is removed and said second portion corresponds to a portion of said packet payload that remains.

14. In a first device communicatively coupled to a network, a method of processing data, said method comprising:
receiving a first authentication value determined using a first plurality of data;
receiving a second plurality of data comprising a subset of said first plurality of data;
receiving first summary information for a third plurality of data corresponding to the difference between said first plurality of data and said second plurality of data; and
using said first summary information to determine second summary information for at least a portion of said second plurality of data, wherein said second summary information and any remaining said second plurality of data comprising said second plurality of data minus said portion are useful for determining a second authentication value that can be compared to said first authentication value to authenticate said any remaining second plurality of data.

15. The method of claim 14 further comprising receiving information sufficient for identifying the length of said third plurality of data.

16. The method of claim 14 further comprising receiving information indicating that said data for said processing comprises different data than that used to determine said first authentication value.

17. The method of claim 14 wherein said first authentication value was determined by processing said first plurality of data in a particular order, wherein said method further comprises receiving information that identifies said order.

18. The method of claim 14 wherein said first plurality of data comprises a data packet, wherein said second plurality of data comprises a truncated version of said data packet.

19. The method of claim 14 further comprising transmitting said first authentication value, said second summary information and said remainder of said second plurality of data to a second device communicatively coupled to said network.

20. The method of claim 14 wherein said portion comprises all of said second plurality of data, wherein said method further comprises comparing said first and second authentication values to determine whether said second plurality of data is authentic.
